(19) United States
(12) Patent Application Publication
(10) Pub. No.: US 2026/0285277 A1
(43) Pub. Date: Sep. 24, 2026

(54) Electro-Pneumatic Brake Device with Automatic Ventilation of the Spring Brake

(71) Applicant: KNORR-BREMSE Systeme fuer Nutzfahrzeuge GmbH, Muenchen (DE)

(72) Inventor: Max MICHALSKI, Neubiberg (DE)

(21) Appl. No.: 19/475,466

(22) PCT Filed: May 3, 2024
(86) PCT No.: PCT/EP2024/062179

§ 371 Date: Oct. 15, 2025

(30) Foreign Application Priority Data
May 24, 2023 (DE) 10 2023 113 581.3

(51) Int. Cl. B60T 13/38; B60T 13/66; B60T 17/22

(52) U.S. Cl. CPC B60T 13/385; B60T 13/662; B60T 17/221; B60T 2220/04; B60T 2270/40

(57) ABSTRACT

An electropneumatic brake device includes an electropneumatic parking brake circuit with spring brake cylinders and a parking brake controller with a pneumatic control connection; at least one operating brake circuit that has operating brake cylinders, which consume compressed air, and at least one compressed air supply under a supply pressure, the compressed air supply providing the compressed air for the operating brake cylinders; an electropneumatic first valve device controlled by an electronic controller via a signal and designed to remove compressed air from the at least one compressed air supply and supply same to the operating brake cylinders on the signal of the electronic controller; and a pneumatically controllable second valve device designed to connect the pneumatic control connection of the parking brake controller to a pressure sink in a first switch position. The pneumatically controllable second valve device is directly or indirectly controlled by the supply pressure in the at least one compressed air supply such that the second valve device assumes the first switch position when the supply pressure falls below a supply pressure threshold. The electronic controller generates the signal regardless of an action of a driver of the motor vehicle.

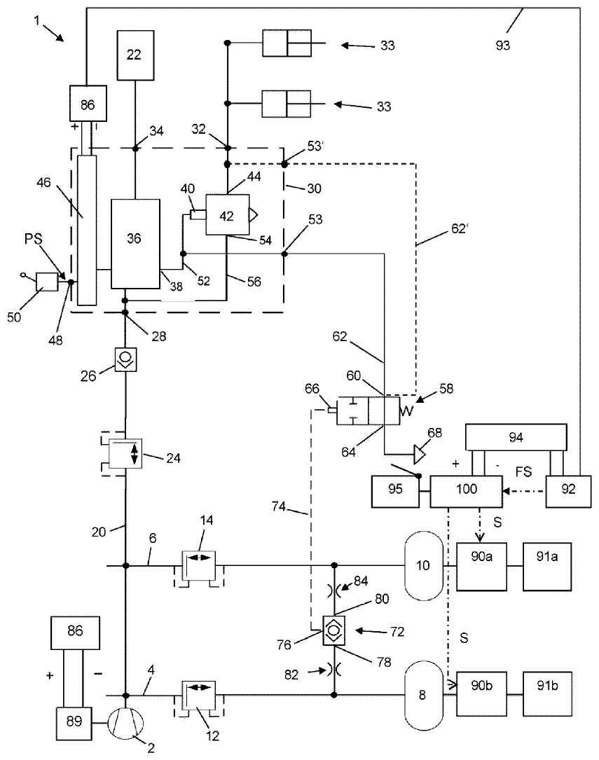

### BACKGROUND AND SUMMARY

The invention relates to an electropneumatic brake device of a motor vehicle and to a motor vehicle having such an electropneumatic brake device.

By way of example, in such electropneumatic brake devices, a failure of the electrical energy supply for the parking brake circuit constitutes a problem because the electromagnetic parking brake valve device is then no longer able to be actuated. In addition, the electronic parking brake controller and electrical parking brake actuation device (parking brake signal transducer) also fail. It has therefore already been proposed to automatically ventilate the spring-loaded brake cylinders of the parking brake circuit if the electrical energy supply for the parking brake circuit fails. However, such emergency braking is problematic during travel because the vehicle may then come to a standstill at an unsuitable location and also because such emergency braking takes place with rapid ventilation of the spring-loaded brake with a high braking force, there being the risk of a collision by following vehicles.

In the generic EP 3 145 769 B1, it was recognized that, in the event of a failure of the compressor (e.g. due to a faulty electrical energy supply or due to a failure of the drive machine), which supplies compressed air to the parking brake circuit and compressed air reservoirs of the service brake circuits, then the service brake circuits being activated (multiple times) by means of the driver actuating a foot brake module causes a decrease in the reservoir pressure in the compressed air reservoirs, which is used to pneumatically actuate the pneumatically controllable valve device to switch said valve device to its ventilation position in which the pneumatic control connection of the parking brake control device is ventilated, which then results in the spring-loaded brake cylinders being automatically applied. The motor vehicle is therefore able to be brought into a safe parked state.

The invention is based on the object of developing an electropneumatic brake device described above in such a way that the safe parked state is able to be assumed in a more flexible manner. Furthermore, a motor vehicle having such an electropneumatic brake device is also intended to be provided.

This object is achieved according to the invention by the features of the independent claims.

The invention is based on an electropneumatic brake device of a motor vehicle, which comprises at least the following:
a) an electropneumatic parking brake circuit having spring-loaded brake cylinders and a parking brake control device with a pneumatic control connection, wherein the parking brake control device is designed and configured to release the spring-loaded brake cylinders when the pneumatic control connection is aerated and to apply the spring-loaded brake cylinders when the pneumatic control connection is ventilated,
b) at least one service brake circuit that comprises service brake cylinders that consume compressed air, and at least one compressed air reservoir at reservoir pressure that provides the compressed air for the service brake cylinders,
c) an electropneumatic first valve device that is controlled by an electronic controller by way of a signal S and is designed and configured, on the basis of the signal S of the electronic controller, to remove compressed air from the at least one compressed air reservoir and to supply it to the service brake cylinders, a pressure sink and/or a compressed air consumer,
d) a pneumatically controllable second valve device that is designed and configured to connect the pneumatic control connection of the parking brake control device to a pressure sink in at least a first switching position, wherein
e) the pneumatically controllable second valve device is controlled directly or indirectly by the reservoir pressure prevailing in the at least one compressed air reservoir in such a way that it assumes the at least one first switching position if the reservoir pressure falls below a reservoir pressure limit value.

The electropneumatic first valve device is therefore designed and configured, on the basis of the signal S of the electronic controller, to remove compressed air from the at least one compressed air reservoir and to supply it to the service brake cylinders and/or a pressure sink and/or a compressed air consumer (of any other type). What is crucial here is merely that the service brake cylinders, the pressure sink or the compressed air consumer removes compressed air from the at least one compressed air reservoir and as a result reduces the reservoir pressure prevailing there, in particular below the reservoir pressure limit value.

If the reservoir pressure therefore falls below the reservoir pressure limit value, then the pneumatically controllable second valve device is switched or controlled by the current (low) reservoir pressure from any switching position, in particular from a second switching position to the first switching position, in which it connects the pneumatic control connection of the parking brake control device to the pressure sink. The low control pressure at the pneumatic control connection of the parking brake control device then causes the spring-loaded brake cylinders to be ventilated and to be applied. In particular, the reservoir pressure limit value may be a predetermined reservoir pressure limit value.

The reservoir pressure may fall below the reservoir pressure limit value in particular if the electronic controller outputs the signal S to the electropneumatic valve device in order to remove compressed air from the at least one compressed air reservoir and if, for example, the compressor has failed. This is because said compressor is not able to redeliver compressed air into the at least one compressed air reservoir, and so then the at least one compressed air tank of the at least one service brake circuit is emptied by (in particular repeatedly) removing compressed air from the at least one compressed air tank as part of at least one service braking operation, which results in the automatic application of the spring-loaded brake cylinders that is described above in order to bring the vehicle into a safe parked state.

The brake device according to the invention may optionally, but does not have to, comprise a service brake actuation device such as a foot brake module or a foot brake valve within the at least one service brake circuit, said foot brake module or a foot brake valve generating a brake request signal produced by an actuation by the driver and inputting it into an electronic service brake controller, which, on the basis of the service brake request signal, actuates the electropneumatic first valve device to remove compressed air from the at least one compressed air reservoir and to supply it to the service brake cylinders.

The invention now builds on the electropneumatic brake device known from EP 3 145 769 B1 in that:

f) the electronic controller is designed and configured to automatically generate the signal S independently of a driver of the motor vehicle actuating the at least one service brake circuit, in particular independently of the driver actuating the service brake actuation device that is optionally present.

On the one hand, the invention is based on the concept that, in particular in the case of a motor vehicle having at least one service brake circuit that is controlled at least partially autonomously, the latter is no longer actuated (solely) by a driver, but rather, for example, (also) actuated by an autopilot device. This then has the result that, in the event of a service braking operation being initiated at least partially autonomously, and redelivery of compressed air into the at least one compressed air reservoir being prevented, for example, for various reasons, said compressed air reservoir is emptied, which then leads to the spring-loaded brake cylinders being automatically applied. By way of example, in this case the signal S represents a brake request signal that is generated at least partially autonomously. The invention therefore also solves the problem arising in EP 3 145 769 B1, according to which the at least one compressed air reservoir must be emptied out by an active brake actuation by the driver, but driver intervention cannot be expected in autonomously controlled service brake circuits.

On the other hand, the invention is based on the concept that the signal S, which ultimately leads to compressed air being removed from the at least one compressed air reservoir, is generated by the electronic controller independently of an action by the driver of the motor vehicle, and therefore entails a higher degree of flexibility. This is because the generation of the signal S may be initiated by the electronic controller due to any cause, which, for example, is not attributable to the driver actuating the service brake. Therefore, generation of the signal S is no longer (only) linked to an actuation of the service brake by the driver, as is the case in EP 3 145 769 B1. Rather, the electronic controller may generate the signal S for any reason, in particular if it detects any fault or a failure of the parking brake circuit and/or of the at least one service brake circuit.

Advantageous developments of and improvements to the invention are possible by means of the measures set out in the dependent claims.

The electronic controller preferably comprises:
a) an electronic service brake control device, and/or
b) a redundant electronic service brake control device, and/or
c) an electronic autopilot controller.

In this case, the electronic service brake control device may in particular control or regulate the at least one service brake circuit. The redundant (secondary) electronic service brake control device may be provided to control or to regulate the at least one service brake circuit if the (primary) electronic service brake control device has a fault or has failed.

The electronic autopilot controller may also at least partially autonomously control or regulate the motor vehicle, and in particular autonomously generate a service brake request signal in particular on the basis of driving and surroundings parameters of the motor vehicle. The electronic autopilot controller may also input the autonomously generated service brake request signal into the (primary) electronic service brake control device and/or into the redundant (secondary) electronic service brake control device for implementation as part of a service braking operation.

Furthermore, the electronic controller may in particular automatically generate the signal S on the basis of a sensor signal FS delivered by a sensor device.

According to one embodiment, the sensor signal FS delivered by the sensor device may comprise a fault signal that indicates or represents at least one of the following failures or faults or irregular states:
a) a failure or fault or irregular state of the parking brake circuit and/or of the at least one service brake circuit, and/or
b) a failure or fault or irregular state of a power supply for the parking brake circuit and/or of the at least one service brake circuit, and/or
c) a failure or fault or irregular state of a drive device of the motor vehicle that drives a compressor supplying compressed air to the at least one compressed air reservoir, and/or
d) a failure or fault or irregular state of the compressor, and/or
e) no or no plausible value for the reservoir pressure in the at least one compressed air reservoir.

The list above is not exhaustive. Therefore, the sensor device may be arranged, configured and designed to detect any failures or faults or irregular states of at least one component, which deviates from the electronic controller and the sensor device, of the brake device. The sensor device may therefore be configured and designed to detect or to identify the failure or fault or irregular state of the at least one component that deviates from the electronic controller and the sensor device, and to generate a fault signal, which corresponds to the failure or fault or the irregular state, as a sensor signal FS, which the electronic controller then evaluates in order to then generate the signal S as required.

According to a further embodiment, the sensor signal FS delivered by the sensor device may comprise a signal generated on the basis of driving and/or surroundings parameters of the motor vehicle. By way of example, the sensor device may then comprise ultrasonic and/or radar and/or camera sensors. By way of example, such driving and surroundings parameters may be the current position, the current speed, the current acceleration of the motor vehicle, in particular also in relation to other objects such as other motor vehicles or to static objects. Distances between the motor vehicle and lane or road boundaries may also be comprised in the driving and/or surroundings parameters. Therefore, all parameters that may be used as input variables for at least partially autonomous control or regulation of the motor vehicle and may be detected by a sensor device should be subsumed here under driving and/or surroundings parameters.

In particular, electrical energy is supplied to the electronic controller and/or to the sensor device from a second electrical power supply that is independent of a first electrical power supply that supplies electrical energy to the parking brake circuit and/or to the service brake circuit.

The electropneumatic first valve device may also be comprised by the at least one service brake circuit and may be designed and configured, on the basis of the signal S,
a) to remove compressed air from the at least one compressed air reservoir and to introduce it into the at least one pneumatic service brake cylinder in order to apply the service brake, or
b) to ventilate the pneumatic service brake cylinders in order to release the service brake.

According to a further development, the electropneumatic first valve device may comprise at least one relay valve (that is in particular electrically and pneumatically controllable) or a pressure regulation modulator of the service brake circuit, said relay valve or pressure regulation modulator controlling or regulating a brake pressure in at least one pneumatic service brake cylinder.

The electronic controller may also be designed to generate the signal S additionally on the basis of an action by the driver, in particular on the basis of the driver actuating a service brake actuation device.

According to one development, the parking brake control device may comprise an electronic parking brake controller, an electromagnetic parking brake valve device controlled thereby, and an air-quantity-boosting valve device with the pneumatic control connection, wherein the electromagnetic parking brake valve device is controlled by the electronic parking brake controller to generate a control pressure for the pneumatic control connection of the air-quantity-boosting valve device.

In particular, the pneumatic control connection of the air-quantity-boosting valve device may be connected to the pneumatically controllable second valve device by way of a first pressure connection. The parking brake control device may also form a structural unit in which at least the electronic parking brake controller, the electromagnetic parking brake valve device and the air-quantity-boosting valve device are integrated.

The electronic parking brake controller may also be controlled on the basis of a parking brake control signal PS of a parking brake actuation device of the parking brake circuit. The parking brake signal may in particular represent the “park” and “drive” states of the motor vehicle as well as, if necessary, the “auxiliary brake/emergency brake” state and/or the “test” state, in which a test is carried out to determine whether the towing vehicle, which is parking-braked by the parking brake circuit, is able to hold the unbraked trailer at a standstill. To implement brake control, the brake device may comprise a trailer control valve or a trailer control module.

The pneumatically controllable second valve device may also be designed and configured to shut off the connection between the pneumatic control connection and the pressure sink in at least a second switching position.

According to one preferred embodiment, the pneumatically controllable second valve device may comprise or be formed by a pneumatically controlled 2/2-way valve, having an inlet that may be connected or is connected to the pneumatic control connection or to a working output of the air-quantity-boosting valve device, an outlet connected to a pressure sink, and having a pneumatic control connection for a reservoir pressure of the at least one compressed air reservoir.

The pneumatically controlled 2/2-way valve may have two switching positions, the first switching position (passage position), which is set at a reservoir pressure in the at least one compressed air reservoir that is lower than the (predetermined) reservoir pressure limit value and in which the inlet is connected to the outlet, and the second switching position (shut-off position), which is set at a reservoir pressure in the at least one compressed air reservoir that is greater than the (predetermined) reservoir pressure limit value and in which the inlet is shut off with respect to the outlet.

In this case, the inlet of the pneumatically controlled 2/2-way valve may be connected or is connected to the control connection or to the working output of the air-quantity-boosting valve device for example directly or indirectly, for example via a further valve device.

Since all the solenoid valves of the electropneumatic parking brake control device are preferably combined or arranged in the electromagnetic parking brake valve device, for example no solenoid valve is arranged in a control air line routed between the outlet of the electromagnetic parking brake valve device and the pneumatic control connection of the air-quantity-boosting valve device, the switching positions of which solenoid valve, which are dependent on energization or non-energization, could impede or prevent a flow connection between the outlet of the electromagnetic parking brake valve device and the pneumatic control connection of the air-quantity-boosting valve device by way of the control air line.

Instead of a pneumatically controlled 2/2-way valve, a pneumatically controlled 3/2-way valve could, however, also be used as a pneumatically controllable second valve device, as well as any combination of pneumatically controlled 2/2-way valves and/or pneumatically controlled 3/2-way valves.

The pneumatically controllable 2/2-way valve that is preferably used in this case is then arranged, for example, in a branch line branching off from the control air line. This affords the advantage that there are no more solenoid valves downstream of the 2/2-way valve, the switching position of which could impede or prevent ventilation of the pneumatic control connection of the air-quantity-boosting valve device. This increases the functional safety and reliability of the brake device.

With regard to the functionality of the electropneumatic brake device, in the case of an intact electrical energy supply for the electric drive machine, if the reservoir pressure in the at least one compressed air reservoir of the at least one service brake circuit drops owing to actuation of the service brake, the compressor, which is driven, for example, by an electric drive machine, counteracts this by way of redelivery, with the result that the (predetermined) reservoir pressure limit value is not fallen below in these circumstances. As a result, the 2/2-way valve remains in or switches into the second switching position (shut-off or driving position), in which the control air line or the pneumatic control connection of the air-quantity-boosting valve device is shut off with respect to the pressure sink.

By way of example, in the event of a failure of the electrical energy supply for the electric drive machine of the compressor, the redelivery by way of the compressor therefore fails, with the result that, if the service brake is repeatedly actuated, the at least one compressed air reservoir of the at least one service brake circuit is emptied and, as a result, the reservoir pressure acting as a control pressure for the 2/2-way valve falls below the reservoir pressure limit value. The 2/2-way valve then switches automatically, for example by way of spring loading, into its first switching position (ventilation or parked position), in which the control air line or the pneumatic control connection of the air-quantity-boosting valve device is ventilated and the spring-loaded brake cylinders that are connected to the working connection of the air-quantity-boosting valve device are applied, in order to apply the parking brake. Since the service brake has previously been repeatedly actuated, for example, to bring about the state in which the reservoir pressure falls below the reservoir pressure limit value, it is assumed that the vehicle is already in a braked state or at a standstill. As a result, there is a high probability of being able to ensure that the parking brake is not automatically engaged until the vehicle is at a standstill.

The 2/2-way valve is preferably formed by a diaphragm valve, the opening pressure of which is able to be set in a simple way, for example by way of a spring, the prestress of which is able to be set. As stated above, the electropneumatic parking brake control device may represent a structural unit, wherein the 2/2-way valve or the pneumatically controllable second valve device may then be integrated into this structural unit or may also form a separate valve device.

The 2/2-way valve is particularly preferably spring-loaded into the second switching position (shut-off position) counter to the action of the reservoir pressure in the at least one compressed air reservoir that prevails at the pneumatic control connection of said 2/2-way valve (normally closed). If the reservoir pressure in the at least one compressed air reservoir then falls below the reservoir pressure limit value, the spring loading of a valve member of the 2/2-way valve ensures an automatic switchover into the first switching position (passage or ventilation position).

The electropneumatic parking brake control device particularly preferably has at least one second output connection for a trailer control valve or a trailer control module, wherein the electromagnetic parking brake valve device is designed such that it outputs a pressure signal that represents the “park” state to the second output connection in the case of a pressure drop in the control air line or at the pneumatic control connection of the air-quantity-boosting valve device that is brought about by way of the passage position of the pneumatically controlled 2/2-way valve. This pressure signal may consist of an aeration or ventilation signal. Since trailer control valves or trailer control modules have an inverting effect with respect to the input pressure, when the pneumatically controllable second valve device (e.g. 2/2-way valve) is switched into the first switching position (passage or parked position), the control pressure at the second output connection for the trailer control valve is reduced, for example, and the brake pressure for the service brakes in the trailer is increased to application pressure as a result. This allows not only the spring-loaded brake cylinders of the towing vehicle, but also the service brakes of the trailer to be automatically applied.

The pressure sink may be formed, for example, by a ventilating connection that opens into the atmosphere or by at least one compressed air reservoir, in particular by the compressed air reservoir that is ventilated or has already been ventilated by the signal S.

Especially when the pressure sink is formed by the at least one compressed air reservoir, a check valve is arranged in a compressed air connection between the inlet of the 2/2-way valve and the control air line according to one development, by way of which check valve a desired compressed air flow from the control air line to the inlet of the 2/2-way valve or to the pressure sink is made possible in the passage position, but an undesired compressed air flow from the inlet or the pressure sink into the control air line is suppressed.

Customary electropneumatic brake devices have an EBS system (electronically regulated brake system) as a service brake, having at least two service brake circuits with in each case one dedicated compressed air reservoir, namely a first service brake circuit with a first compressed air reservoir and a second service brake circuit with a second compressed air reservoir. Preferably, in the case of such an electropneumatic brake device, a selection device is provided to forward the higher reservoir pressure of the reservoir pressures of the compressed air reservoirs (first compressed air reservoir, second compressed air reservoir) to the pneumatic control connection of the pneumatically controllable second valve device, having a first inlet connected to the first compressed air reservoir of the first service brake circuit, a second inlet connected to the second compressed air reservoir of the second service brake circuit and an outlet connected to the pneumatic control connection of the pneumatically controllable second valve device. This selection device is formed, for example, by a shuttle valve, which then forms a logic “OR” gate.

As a result of these measures, the control pressure for the pneumatically controllable second valve device is formed by the respectively higher reservoir pressure of the service brake circuits, with the result that a failure of a single service brake circuit, for example on account of a leak, does not already lead to a reservoir pressure in this service brake circuit that is below the reservoir pressure limit value and then lead to an unnecessary switchover of the pneumatically controllable second valve device into the first switching position (passage or parked position), since such a case of leaking does not necessarily constitute a reason to bring the motor vehicle into the safe parking state. These measures therefore improve the functional safety of the electropneumatic brake device.

According to one development, in each case one throttle device is provided between the first compressed air reservoir and the first inlet of the selection device and between the second compressed air reservoir and the second inlet of the selection device, the throttle cross section of which throttle device is at least so small that a volumetric flow that has occurred unintentionally between the first inlet and the second inlet of the selection device is smaller than a minimum delivery volumetric flow that the compressor is capable of redelivering into the compressed air reservoirs at a minimum delivery output. Such an undesired volumetric flow between the first inlet and the second inlet of the selection device may be formed, for example, by an intermediate position of the selection device or the shuttle valve. These measures therefore also improve the functional safety of the electropneumatic brake device.

The invention also relates to a motor vehicle having an electropneumatic brake device described above, in particular a utility vehicle in the form of a towing vehicle, which is equipped for trailer operation. Further measures that improve the invention will be presented in more detail below together with the description of an exemplary embodiment of the invention on the basis of the drawing.

### BRIEF DESCRIPTION OF THE DRAWING

The single FIGURE is a schematic circuit diagram of a detail of an electropneumatic brake device of a towing vehicle of a towing-vehicle/trailer combination according to one preferred embodiment of the invention.

### DETAILED DESCRIPTION OF THE DRAWING

The FIGURE shows a detail of an electropneumatic brake device 1 of a towing-vehicle/trailer combination with a service brake and a parking brake. The electropneumatic brake device 1 preferably comprises a brake system that is regulated electronically with regard to the brake pressure (EBS) as a service brake.

Compressed air is supplied to the electropneumatic brake device 1 in a known manner from a compressor 2 that in this case is driven, for example, by an electric drive machine 89. To this end, the compressor 2 is connected to two compressed air reservoirs 8, 10 via two compressed air supply lines 4, 6, wherein each of the compressed air reservoirs 8, 10 is, for example, assigned to a service brake circuit of the service brake. In each case one overflow valve 12, 14, with a known purpose or function, is arranged in the compressed air supply lines 4, 6 between the compressor 2 and the compressed air reservoirs 8, 10. To this extent, the circuits are separated.

A further element of the service brake circuits may form an optional service brake actuation device 95, in this case, for example, a foot brake module, which allows the driver to actuate the service brake and inputs an actuation-dependent service brake request signal into an electronic controller 100, in which, for example, an EBS brake control device is integrated in this case. On the basis of the service brake request signal, the EBS brake control device then actuates an electropneumatic first valve device, which in this case comprises, for example, a first pressure regulation module 90a and a second pressure regulation module 90b, to remove compressed air from the two compressed air reservoirs 8, 10 and to supply it to the service brake cylinders 91a, 91b. The service brake actuation device 95, which may be actuated by the driver, may, however, also be omitted if the service brake circuits are actuated exclusively by an autonomously generated service brake request signal.

A compressed air supply line 20 for a parking brake circuit branches off from the two compressed air supply lines 4, 6 of the two service brake circuits. In this case, compressed air is therefore supplied to the parking brake from the compressed air reservoirs 8, 10 of the service brake circuits. Alternatively, a dedicated compressed air reservoir could also be provided for the parking brake circuit.

An overflow valve 24 and a check valve 26 are arranged in the compressed air supply line 20 of the parking brake circuit in order to protect the circuit. The compressed air supply line 20 of the parking brake circuit is furthermore connected to a reservoir connection 28 of an electropneumatic parking brake control device 30, using which various functions or states in connection with the parking brake are able to be controlled, in particular known states or functions such as “drive”, “park”, “test”, “anti-jackknife brake” and “auxiliary or emergency brake”.

Since the electropneumatic parking brake control device 30 may preferably be in the form of a structural unit and as such may be connected to the electropneumatic brake device 1, it may also be referred to as a parking brake module (electronic parking brake module, EPBM). By way of example, two spring-loaded brake cylinders 33 on the rear axle of the towing vehicle are connected to a first output connection 32 of the electropneumatic parking brake control device 30. A second output connection 34 is connected to an electropneumatic trailer control valve or module 22 that controls the trailer brakes.

The electropneumatic parking brake control device 30 includes an electromagnetic parking brake valve device 36, which is shown here merely in simplified form as a small box, with solenoid valves such as an inlet valve, outlet valve, bistable valve, etc., by way of which parking brake valve device a pneumatic control pressure is generated, inter alia at a connection 38, for a pneumatic control connection 40 of a relay valve 42, the working output 44 of which is connected to the first output connection 32. Furthermore, the second output connection 34 for the trailer control module 22 is connected to the parking brake valve device 36 in a controllable manner.

The electropneumatic parking brake control device 30 includes an electronic parking brake controller 46 for controlling the solenoid valves of the electropneumatic parking brake valve device 36, inter alia on the basis of parking brake signals PS that are input via a parking brake signal connection 48 and are generated by a parking brake signal transducer 50, which is able to be actuated by the driver, such as a rocker switch or an operating lever. Furthermore, signals from integrated sensor devices, such as pressure sensors, for example, are input into the electronic parking brake controller 46, which sensor devices measure the actual pressures at the output connections 32, 34, in order to realize a parking brake pressure regulation operation, as is advantageous, for example, as part of an auxiliary braking operation, by way of a target/actual value comparison in the parking brake controller 46. Compressed air from the parking brake circuit is supplied to the pneumatic part of the electromagnetic parking brake valve device 36 by way of the reservoir connection 28.

The control connection 40 of the relay valve 42 is connected to the outlet 38 of the electromagnetic parking brake valve device 36 via a control air line 52 and a reservoir input 54 is connected to the reservoir connection 28 via a compressed air connection 56. It modulates a working pressure at its working output 44 based on the reservoir pressure on the basis of the control pressure that prevails in the control air line 52 and is output by the electromagnetic parking brake valve device 36, which working pressure is then input into the spring-loaded brake cylinders 33 via the first output connection 32. The first output connection 32 is ventilated to apply the spring-loaded brake cylinders 33 and is aerated to release same.

Since all the solenoid valves or electrically actuated components are preferably combined in the electromagnetic parking brake valve device 36, there are also preferably no solenoid valves in the control air line 52. However, a shuttle valve in the control air line is contemplated, which shuttle valve controls the greater pressure of the control pressure that is output by the parking brake valve device 36 and a service brake pressure that is input via a service brake pressure connection, which is not shown here, at the control connection 40 of the relay valve 42, for anti-compound reasons. For the connection of the first pressure connection 62 to the parking brake control device 30, a corresponding third output connection 53 is provided on the latter.

Furthermore, the brake device comprises, for example, a pneumatically controlled 2/2-way valve 58, having an inlet 60 that in this case is preferably directly connected to the control air line 52 via a first pressure connection 62, an outlet 64 that is connected to a pressure sink 68, and having a pneumatic control connection 66 for a reservoir pressure of the service brake. In the exemplary embodiment of the FIGURE, for example, the pressure sink is formed by a ventilation means 68 of the 2/2-way valve 58.

As shown in the FIGURE by way of the first pressure connection 62′, which is shown as a dash-dotted line, the inlet 60 of the pneumatically controlled 2/2-way valve 58 may alternatively be connected or be able to be connected to the working output 44 of the relay valve 42 or to the first output connection 32, optionally also by means of a further valve device. A corresponding connection 53′ is then provided. Alternatively, the first pressure connection 62′ could also be connected to the first output connection 32.

The pneumatically controlled 2/2-way valve 58 has two positions, a first switching position (passage or parked position), which is set at a reservoir pressure in at least one of the compressed air reservoirs 8, 10 at the control connection 66 that is lower than a reservoir pressure limit value, which is, for example, predetermined, and in which the inlet 60 is connected to the outlet 64, and second switching position (shut-off or driving position), which is set at a reservoir pressure in at least one of the compressed air reservoirs 8, 10 that is greater than the reservoir pressure limit value and in which the inlet 60 is shut off with respect to the outlet 64.

The 2/2-way valve 58 is preferably a diaphragm valve that is controlled by the control pressure at its pneumatic control connection 66 and is, for example, spring-loaded into its first switching position (passage or parked position). If the reservoir pressure then falls below the reservoir pressure limit value, the spring loading of a valve member that is connected to the diaphragm automatically switches over the 2/2-way valve 58 into the first switching position (passage or parked position). However, if the reservoir pressure at the pneumatic control connection 66 of said 2/2-way valve is greater than or equal to the reservoir pressure limit value, the reservoir pressure forces the valve member into the second switching position (shut-off or driving position).

The 2/2-way valve 58, which in this case is merely an example of a pneumatically controllable valve device and in this case preferably represents a separate structural unit, may also, however, be integrated into the electropneumatic parking brake control device 30.

The first pressure connection 62 branches off from the control air line 52 at a point between the outlet 38 of the electromagnetic parking brake valve device 36 and the control connection 40 of the relay valve 42, with the result that, for example, the control connection 40 of the relay valve 42 is directly connected to the inlet 60 of the 2/2-way valve 58 here without solenoid valves being connected in between. In this respect, the connection of the inlet 60 of the 2/2-way valve 58 to the control connection 40 of the relay valve 42 may certainly be referred to as direct.

In this case, a selection device is preferably provided in the form of a shuttle valve 72 (Select High) for forwarding the higher reservoir pressure of the reservoir pressures of the compressed air reservoirs 8, 10 to the pneumatic control connection 66 of the 2/2-way valve 58. To this end, the pneumatic control connection 66 is connected via a second pressure connection 74 to an outlet 76 of the shuttle valve 72, the first inlet 78 of which is connected to the first compressed air reservoir 8 of the first service brake circuit and the second inlet 80 of which is connected to the second compressed air reservoir 10 of the second service brake circuit.

The shuttle valve 72 then forms a logic “OR” gate in relation to the reservoir pressures in the compressed air reservoirs 8, 10. As a result of these measures, the control pressure for the 2/2-way valve 58 is formed by the higher reservoir pressure of the service brake circuits in each case.

In each case one throttle device 82, 84 is particularly preferably provided between the first compressed air reservoir 8 and the first inlet 78 of the shuttle valve and between the second compressed air reservoir 10 and the second inlet 80 of the shuttle valve. In the two throttle devices 82, 84, the throttle cross section is at least so small that a volumetric flow that has occurred unintentionally between the first inlet 78 and the second inlet 80 of the shuttle valve 72, for example as a result of an undefined intermediate position of the valve member of the shuttle valve 72, is smaller than a minimum delivery volumetric flow that the compressor 2 is capable of redelivering into the compressed air reservoirs 8, 10 at a minimum delivery output.

In this case, current is supplied to the parking brake control device 30 and the electric drive machine 89 of the compressor 2 from a first electrical energy source such as a battery 86.

The electropneumatic brake device furthermore comprises the first pressure regulation module 90a in the first service brake circuit and the second pressure regulation module 90b in the second service brake circuit, wherein compressed air is supplied to the first pressure regulation module 90a from the first compressed air reservoir 8 and to the second pressure regulation module 90b from the second compressed air reservoir 10.

The two pressure regulation modules 90a, 90b are controlled by an electronic controller 100, which in this case, for example, comprises the EBS brake control device, in order to adjust a target service brake pressure in the respectively connected first and second pneumatic service brake cylinders 91a, 91b on the basis of a brake request signal S that in this case is generated autonomously, i.e. without an action by the driver. The brake request signal S that is autonomously generated in this case therefore contains the information concerning the target service brake pressure in the first and second pneumatic service brake cylinders 91a, 91b. In this case, for example, in addition to the EBS brake control device, an electronic autopilot controller is therefore integrated into the electronic controller 100, which then generates the electrical brake request signal S for the pressure regulation modules 90a, 90b autonomously, i.e. without an action by the driver, i.e. without the driver actuating the foot brake module that is additionally still present in this case, for example. The brake request signal S may be automatically generated on the basis of any circumstances, that are in particular independent of an action by the driver, for example in the form of a brake request signal S that is autonomously generated by the electronic autopilot controller and/or else in the form of a brake request signal S that is generated on the basis of a sensor signal FS, as will be explained below.

In this case, the pressure regulation modules 90a, 90b are, for example, constructed in a known manner and each comprise an integrated electronic control device, an integrated inlet-outlet valve combination that is electrically controlled by said control device, an integrated relay valve that is pneumatically controlled by said inlet-outlet valve combination, and an integrated pressure sensor that inputs the actual service brake pressure output by the relay valve into the integrated electronic control device for comparison with the target service brake pressure. A backup solenoid valve may also be integrated, which in normal operation retains a pneumatic control pressure output by the driver-actuated foot brake module, which in this case is not present, but is not shown, and only switches through to the control connection of the relay valve in the event of a failure of the electrical controller.

The electronic controller 100 receives sensor signals FS, which in this case represent faults or failures of the first electrical energy supply 86 as fault signals, for example, from a sensor device 92. To this end, the sensor device 92 is connected to the first electrical energy supply 86 via a signal line 93 and measures, for example, the voltage thereof.

In this case, for example, electrical energy is supplied to the electronic controller 100, the sensor device 92 and the first and second pressure regulation modules 90a, 90b from a second electrical energy supply 94 that is independent of the first electrical energy supply 86.

Against this background, the method of operation of the brake device 1 is as follows here, for example with regard to the functionality of the first electrical energy supply 86.

In the case of an intact first electrical energy supply 86 (e.g. voltage U greater than or equal to a permissible lower voltage limit value Ugrenz) that is detected by the sensor device 92 and reported to the electronic controller 100, the electric drive machine 89 drives the compressor 2 in order to counteract the lowering of the reservoir pressure in the compressed air reservoirs 8, 10 of the two service brake circuits, which is caused by a brake request signal S generated by actuation of the brake pedal of the foot brake module or by the electronic controller 100, by way of redelivery, with the result that the reservoir pressure limit value is not fallen below in these circumstances. As a result, the 2/2-way valve 58 remains in or switches into the second switching position (shut-off or driving position), in which the control air line 52 of the relay valve 42 is shut off with respect to the pressure sink 68. The electronic controller 100 then does not generate an autonomous brake request signal S solely on the basis of the delivered signals of the sensor device 92, because it evaluates these signals to mean that the first electrical energy supply 86 is intact.

In the case of a failure of the first electrical energy supply 86 (voltage U less than the permissible lower voltage limit value Ugrenz) that is detected by the sensor device 92 and reported to the electronic controller 100 by the sensor signal FS then generated, the electric drive machine 89 of the compressor 2 fails, however, and therefore the redelivery of compressed air into the compressed air reservoirs 8, 10 by the compressor 2 also fails. Furthermore, the parking brake circuit is also no longer able to be actuated by the parking brake signal transducer 50.

In response to the sensor signal FS generated by the sensor device 92 as a fault signal in this case, the electronic controller 100 then automatically generates, for example, at least one brake request signal S for the two pressure regulation modules 90a, 90b, which then remove compressed air from the compressed air reservoirs 8, 10 and use it to modulate or adjust the regulated brake pressure for the pneumatic service brake cylinders. Preferably, the electronic controller 100 automatically successively generates a plurality of brake request signals S, with the result that the motor vehicle is braked to a low speed or to a standstill and the compressed air reservoirs 8, 10 are emptied over time. As a result, the reservoir pressure acting as the control pressure for the 2/2-way valve 58 decreases below the reservoir pressure limit value, upon which said 2/2-way valve switches over into its first switching position (shown in the FIGURE) in which the control connection 40 of the relay valve 42 is connected to the pressure sink 68. As explained above, this ventilates the spring-loaded brake cylinders 33 and automatically applies the parking brake of the towing vehicle, as a result of which the towing vehicle is automatically brought into the safe parked state.

Since the second electrical energy supply 94 is still intact, the sensor device 92, the electronic controller 100 and the pressure regulation modules 90a, 90b may act as described above.

The pressure drop in the control air line 52 is also input via the connection 38 into the parking brake valve device 36, which is designed such that, in the case of such a pressure drop at its connection 38, it inputs a pressure signal representing a parked position at the second output connection 34 for the trailer control valve 22. This pressure signal may consist of an aeration or ventilation of the second connection 34, depending on whether the brakes of the trailer are intended to be applied or released during parking. The pressure drop in the control air line 52 or at the connection 38 ensures, for example at a pneumatic control input of a bistable valve, which is (also) pneumatically controlled, within the parking brake valve device 36, that the bistable valve outputs the pressure signal representing the parked position to the second output connection 34 for the trailer control valve 22.

In this case, the trailer brakes are preferably also intended to be applied during parking. Since trailer control valves 22 have an inverting effect with respect to the input pressure, when the 2/2-way valve 58 is switched into the passage or parked position owing to the failure of the electrical energy supply 86 and in the case of the pressure drop in the control air line, and therefore at the connection 38, that is brought about as a result, the parking brake valve device 36 is controlled in such a way that the control pressure at the second output connection 34 and also at the trailer control valve 22 is reduced, and the brake pressure for the brakes in the trailer is increased to application pressure as a result. As a result, in the event of a failure of the first electrical energy supply 86, not only the spring-loaded brake cylinders 33 of the towing vehicle, but also the service brakes of the trailer are preferably automatically applied.

Due to the shuttle valve 72, the control pressure for the 2/2-way valve 58 is formed by the respectively higher reservoir pressure of the service brake circuits, with the result that a failure of a single service brake circuit, for example on account of a leak, does not already lead to a reservoir pressure in this service brake circuit that is below the pressure limit value and then lead to an unnecessary switchover of the 2/2-way valve 58 into the passage or parked position, since there does not necessarily also have to be a failure of the first electrical energy supply 86 in such a case of leaking.

With respect to the above case, in which the first electrical energy supply 86 has failed and the parking brake circuit is then no longer able to be actuated, monitoring of the functionality of the first electrical energy supply 86 by a sensor device 92 is, however, not absolutely necessary in order to automatically generate a brake request signal S, which then leads to a pressure drop in the compressed air reservoirs 8, 10.

This is because if, for example, the brake request signal S is autonomously generated by the electronic autopilot controller that is in this case integrated in the electronic controller 100, for example, in particular as part of at least one autonomously triggered service braking operation, this also leads to the reservoir pressure in the compressed air reservoirs 8, 10 falling below the reservoir pressure limit value, upon which the 2/2-way valve 58 is then also controlled into the first switching position (passage or parked position). By way of example, the service braking operation may be autonomously triggered on the basis of driving and surroundings parameters, which are in turn detected by a sensor device.

In other words, only at least one autonomously triggered service braking operation ensures that the towing vehicle is automatically braked to a low speed or to a standstill using the service brake, and in particular without any intervention or action by the driver, and then the parking brake is also automatically applied in order to establish a safe parked state at least of the towing vehicle.

The electronic controller 100 is therefore designed and configured to automatically generate the signal S, in this case in the form of a brake request signal S, (also) independently of a driver of the motor vehicle actuating the service brake actuation device 95. In addition, however, the option should continue to exist for the electronic controller 100 to generate the brake request signal S (also) on the basis of the driver of the motor vehicle actuating the service brake actuation device 95.

List of reference signs

| | |
|---|---|
| 1 | Electropneumatic brake device |
| 2 | Compressor |
| 4 | Compressed air supply line |
| 6 | Compressed air supply line |
| 8 | Compressed air reservoir |
| 10 | Compressed air reservoir |
| 12 | Overflow valve |
| 14 | Overflow valve |
| 20 | Compressed air supply line |
| 22 | Trailer control valve |
| 24 | Overflow valve |
| 26 | Check valve |
| 28 | Reservoir connection |
| 30 | Parking brake control device |
| 32 | First output connection |
| 33 | Spring-loaded brake cylinder |
| 34 | Second output connection |
| 36 | Parking brake valve device |
| 38 | Connection |
| 40 | Control connection |
| 42 | Relay valve |
| 44 | Working output |
| 46 | Parking brake controller |
| 48 | Parking brake signal connection |
| 50 | Parking brake signal transducer |
| 52 | Control air line |
| 53 | Third output connection |
| 54 | Reservoir input |
| 56 | Compressed air connection |
| 58 | 2/2-way valve |
| 60 | Inlet |
| 62 | First pressure connection |
| 64 | Outlet |
| 66 | Control connection |
| 68 | Ventilation means |
| 72 | Shuttle valve |
| 74 | Second pressure connection |
| 76 | Outlet |
| 78 | First inlet |
| 80 | Second inlet |
| 82 | Throttle device |
| 84 | Throttle device |
| 86 | First electrical energy supply |
| 89 | Electric drive machine |
| 90a | First pressure regulation module |
| 90b | Second pressure regulation module |
| 91a | First pneumatic service brake cylinder |
| 91b | Second pneumatic service brake |
| 92 | Sensor device |
| 93 | Signal line |
| 94 | Second electrical energy supply |
| 95 | Service brake actuation device |
| 100 | Electronic controller |
| S | Signal |
| FS | Sensor signal |
| PS | Parking brake signal |

1.-16. (canceled)

17. An electropneumatic brake device of a motor vehicle, comprising:
a) an electropneumatic parking brake circuit having spring-loaded brake cylinders and a parking brake control device with a pneumatic control connection, wherein the parking brake control device is configured to release the spring-loaded brake cylinders when the pneumatic control connection is aerated and to apply the spring-loaded brake cylinders when the pneumatic control connection is ventilated;
b) at least one service brake circuit that comprises service brake cylinders that consume compressed air, and at least one compressed air reservoir at reservoir pressure that provides the compressed air for the service brake cylinders;
c) an electropneumatic first valve device that is controlled by an electronic controller by way of a signal and is configured, based on the signal of the electronic controller, to remove compressed air from the at least one compressed air reservoir and to supply the compressed air to the service brake cylinders, a pressure sink and/or a compressed air consumer;
d) a pneumatically controllable second valve device that is configured to connect the pneumatic control connection of the parking brake control device to a pressure sink in at least a first switching position,
e) wherein the pneumatically controllable second valve device is controlled directly or indirectly by the reservoir pressure prevailing in the at least one compressed air reservoir such that the second valve device second valve device assumes the first switching position when the reservoir pressure falls below a reservoir pressure limit value, and
f) the electronic controller is configured to automatically generate the signal independently of a driver of the motor vehicle actuating the at least one service brake circuit.

18. The brake device as claimed in claim 17, wherein the electronic controller forms at least one of:
a) an electronic service brake control device,
b) a redundant electronic service brake control device, or
c) an electronic autopilot controller.

19. The brake device as claimed in claim 17, wherein
the electronic controller is configured to automatically generate the signal based on a sensor signal delivered by a sensor device.

20. The brake device as claimed in claim 19, wherein the sensor signal delivered by the sensor device comprises a fault signal that indicates at least one of the following failures, faults or irregular states:
a) a failure or fault or irregular state of the parking brake circuit and/or of the at least one service brake circuit,
b) a failure or fault or irregular state of a power supply for the parking brake circuit and/or of the at least one service brake circuit,
c) a failure or fault or irregular state of a drive device that drives a compressor supplying compressed air to the at least one compressed air reservoir,
d) a failure or fault or irregular state of the compressor, or
e) no or no plausible value for the reservoir pressure prevailing in the at least one compressed air reservoir.

21. The brake device as claimed in claim 19, wherein
the sensor signal delivered by the sensor device comprises a signal generated based on driving and/or surroundings parameters of the motor vehicle.

22. The brake device as claimed in claim 19, wherein
electrical energy is supplied to the electronic controller and/or to the sensor device from a second electrical power supply that is independent of a first electrical power supply that supplies electrical energy to the parking brake circuit and/or to the service brake circuit.

23. The brake device as claimed in claim 17, wherein the electropneumatic first valve device comprises the at least one service brake circuit and is configured based on the signal, to:
a) remove compressed air from the at least one compressed air reservoir and to introduce it into the at least one pneumatic service brake cylinder in order to apply the service brake, or
b) ventilate the pneumatic service brake cylinders in order to release the service brake.

24. The brake device as claimed in claim 23, wherein
the electropneumatic first valve device comprises at least one relay valve or a pressure regulation modulator of the service brake circuit, said relay valve or pressure regulation modulator controlling or regulating a brake pressure in at least one pneumatic service brake cylinder.

25. The brake device as claimed in claim 17, wherein
the electronic controller is designed to generate the signal additionally on the basis of an action by the driver, actuating a service brake actuation device.

26. The brake device as claimed in claim 17, wherein
the parking brake control device comprises an electronic parking brake controller, an electromagnetic parking brake valve device controlled thereby, and an air-quantity-boosting valve device with the pneumatic control connection, and
the electromagnetic parking brake valve device is controlled by the electronic parking brake controller to generate a control pressure for the pneumatic control connection of the air-quantity-boosting valve device.

27. The brake device as claimed in claim 26, wherein
the electronic parking brake controller is controlled-based on a parking brake control signal of a parking brake actuation device of the parking brake circuit.

28. The brake device as claimed in claim 17, wherein
the pneumatically controllable second valve device is configured to shut off the connection between the pneumatic control connection and the pressure sink in at least a second switching position.

29. The brake device as claimed in claim 17, wherein
a pneumatic control connection of the pneumatically controllable second valve device is connected indirectly or directly to the at least one compressed air reservoir.

30. The brake device as claimed in claim 29, wherein
at least two service brake circuits with, in each case, one dedicated compressed air reservoir, are provided as a first service brake circuit with a first compressed air reservoir and a second service brake circuit with a second compressed air reservoir,
a selection device is provided to forward the higher reservoir pressure of the reservoir pressures of the first and second compressed air reservoirs to the pneumatic control connection of the pneumatically controllable second valve device, having a first inlet connected to the first compressed air reservoir of the first service brake circuit, a second inlet connected to the second compressed air reservoir of the second service brake circuit and an outlet connected to the pneumatic control connection of the pneumatically controllable second valve device.

31. The brake device as claimed in claim 30, the selection device is a shuttle valve.

32. A motor vehicle comprising an electropneumatic brake device as claimed in claim 17.
